(19) United States
(12) Patent Application Publication
(10) Pub. No.: US 2009/0051167 A1
(43) Pub. Date: Feb. 26, 2009

(54) Combustion turbine cooling media supply method

(75) Inventor: Constantin A. Dinu, Greer, SC (US)

Correspondence Address: NIXON & VANDERHYE P.C., 901 NORTH GLEBE ROAD, 11TH FLOOR, ARLINGTON, VA, 22203, US

(73) Assignee: GENERAL ELECTRIC COMPANY, Schenectady, NY (US)

(21) Appl. No.: 11/892,354

(22) Filed: Aug. 22, 2007

(51) Int. Cl. F02C 6/08

(52) U.S. Cl. 290/52; 60/782

(57) ABSTRACT

A land based gas turbine apparatus includes an integral compressor; a turbine component having a combustor to which air from the integral compressor and fuel are supplied; and a generator operatively connected to the turbine for generating electricity; wherein hot gas path component parts in the turbine component are cooled entirely or at least partially by cooling air or other cooling media supplied by an external compressor. A method is also provided which includes the steps of supplying compressed air to the combustor from the integral compressor; and supplying at least a portion of the cooling air or other cooling media to the hot gas path parts in the turbine component from an external compressor.

This invention relates to supplying augmenting compressed air and/or cooling media to a combustion turbine via a separate compressor.

### BACKGROUND OF THE INVENTION

Most combustion turbines use air bled from one or more locations of the integral compressor to provide for cooling and sealing in the turbine component. Air bled from the compressor for this purpose may be routed internally through the bore of the compressor-turbine rotor or other suitable internal passages to the locations that require cooling and sealing in the turbine section. Alternatively, air may be routed externally through the compressor casing and through external (to the casing) piping to the locations that require cooling and sealing. Many combustion turbines utilize a combination of the internal and external routing of cooling and sealing air to the turbine component. Some combustion turbines use heat exchangers to cool the cooling and sealing air routed through the external piping before introduction into the turbine component.

The output or capacity of a combustion turbine usually falls off with increasing temperature at the inlet to the compressor component. Specifically, the capacity of the compressor component to supply air to the combustion process and subsequent expansion through the turbine is reduced as the compressor inlet temperature is increased (usually due to increased ambient temperature). Thus, the turbine component and combustion component of the combustion turbine usually have the capability to accept more compressed air than the compressor component can supply when operating above a certain inlet temperature.

### BRIEF DESCRIPTION OF THE INVENTION

The invention augments the compressed air and/or cooling media supplied by the integral compressor using a separate compressor. Thus, the invention may be embodied in a land based combustion gas turbine apparatus comprising: an integral compressor; a turbine component; a combustor to which air from the integral compressor and fuel are supplied, said combustor arranged to supply hot combustion gases to the turbine component; a generator operatively connected to the turbine for generating electricity; and an external compressor arranged and connected to supply cooling air or other cooling media to hot gas path component parts in said turbine component, said external compressor also being arranged and connected to selectively supply atomizing air to atomize said fuel supplied to said combustor.

The invention may also be embodied in a land based combustion gas turbine apparatus comprising: an integral compressor; a turbine component; a combustor to which air from the integral compressor and fuel are supplied, said combustor arranged to supply hot combustion gases to the turbine component; a generator operatively connected to the turbine for generating electricity; an external compressor arranged and connected to supply compressed air to a storage chamber for selectively storing said compressed air, an outlet of said storage chamber being connected to supply said compressed air as cooling media from the storage tank to hot gas path component parts in said turbine component.

The invention may also be embodied in a land based combustion gas turbine apparatus comprising: an integral compressor; a turbine component; a combustor to which air from the integral compressor and fuel are supplied, said combustor arranged to supply hot combustion gases to the turbine component; a generator operatively connected to the turbine for generating electricity; an external compressor arranged and connected to supply cooling air or other cooling media to hot gas path component parts in said turbine component; and an external turbine for producing at least some of the work required to compress the cooling air in the external compressor, wherein said integral compressor is operatively coupled to said external turbine for selectively supplying compressed air from said integral compressor to said external turbine.

The invention may also be embodied in a method of insuring peak power capability for a land based gas turbine power plant including an integral compressor, a turbine component, a combustor and a generator, wherein hot gas path parts in the turbine component are cooled by cooling air, the method comprising: a) supplying compressed air to said combustor from said integral compressor; b) supplying cooling air or other cooling media to said hot gas path parts in the turbine component from an external compressor; and c) supplying compressed air from said external compressor to atomize fuel supplied to the combustor.

### BRIEF DESCRIPTION OF THE DRAWINGS

These and other objects and advantages of this invention, will be more completely understood and appreciated by careful study of the following more detailed description of the presently preferred example embodiments of the invention taken in conjunction with the accompanying drawings, in which:

FIG. 1 is a schematic diagram of a prior art cooling arrangement for a combustion turbine;

FIG. 2 is a schematic diagram of another prior art cooling arrangement for a combustion turbine;

FIG. 3 is a schematic diagram of yet another prior art cooling arrangement for a combustion turbine;

FIG. 4 is a schematic diagram of a further prior art cooling arrangement for a combustion turbine;

FIG. 5 is a schematic diagram of a cooling arrangement for a combustion turbine in accordance with an example embodiment of the invention;

FIG. 6 is a schematic diagram of a cooling arrangement for a combustion turbine in accordance with another example embodiment of the invention; and

FIG. 7 is a schematic diagram of a cooling arrangement for a combustion turbine in accordance with yet another example embodiment of the invention.

### DETAILED DESCRIPTION OF THE INVENTION

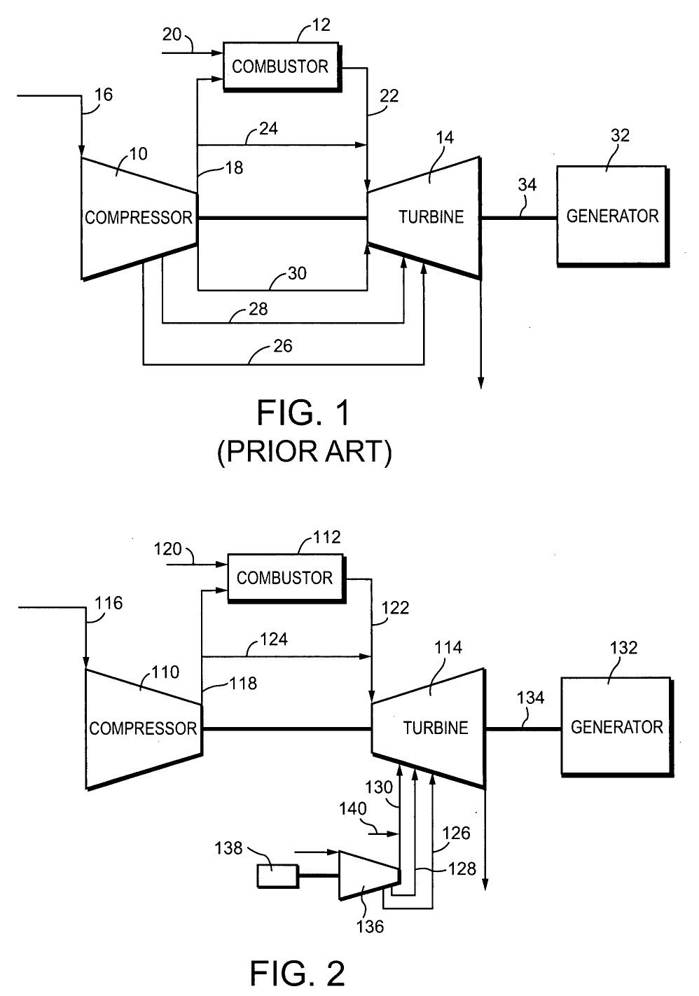

FIG. 1 represents a conventional cooled combustion turbine system including an integral compressor 10, combustor 12 and turbine component 14. The compressor 10, turbine section 14 and generator 32 are shown in a single shaft configuration with the single shaft 34 also driving the generator 32.

Inlet air is supplied to the compressor via stream 16. Compressor air is extracted from various locations in the compressor and supplied to the locations in the turbine component 14 that require cooling and sealing. The extraction locations are chosen to supply air at required pressures. Flow streams 26, 28 and 30 represent cooling air extractions from the integral compressor that are routed to the turbine section of the machine for cooling and sealing hot gas path component parts. Streams 26 and 28, which supply the low and intermediate pressure coolant, respectively, may be routed via piping external to the compressor casing, and reintroduced through the turbine casing into the parts that need cooling. Stream 30 supplies the highest pressure coolant and is typically routed internally of the machine, for example, through the bore of the compressor-turbine rotor. The remaining compressed air is supplied at high pressure to the combustor via stream 18 where it mixes with fuel supplied by stream 20.

The hot combustion gas is supplied to the turbine component 14 via stream 22. Some compressor air may be diverted to bypass the combustor via stream 24, entering the hot combustion gases before they enter the turbine.

FIG. 2 illustrates an example of a prior art cooled combustion turbine system wherein the supply of pressurized cooling air to the turbine components is through use of an external compressor. The FIG. 2 cooled combustion turbine system is disclosed in U.S. Pat. No. 6,389,793, the entire disclosure of which is incorporated herein by this reference.

For the sake of convenience and ease of understanding, reference numerals similar to those used in FIG. 1 are applied to corresponding components in FIG. 2, but with the prefix “1” added. As in the conventional system described above, inlet air is supplied to the compressor 110 via stream 116. Compressed air is supplied to the combustor 112 via stream 118 where it mixes with fuel supplied to the combustor via stream 120. Bypass air may be supplied to the hot combustion gases via stream 124. Here, however, the respective low, intermediate and high pressure cooling air streams 126, 128 and 130 (or other cooling media) are generated by a separate external compressor 136 driven by a motor 138. In this embodiment, all of the air or other cooling media is supplied by the external compressor 136, thus allowing more of the combustion turbine compressor air to be used in the combustion process. Because the compressor 136 can be dedicated for supplying only cooling air or other cooling media, the cooling requirements of the turbine component 114 can be met regardless of compressor capability variations due to increased ambient temperatures. In other words, because the integral compressor 110 is freed from cooling duty requirements, sufficient air is available to satisfy the capability of the combustor and turbine component, thereby increasing output.

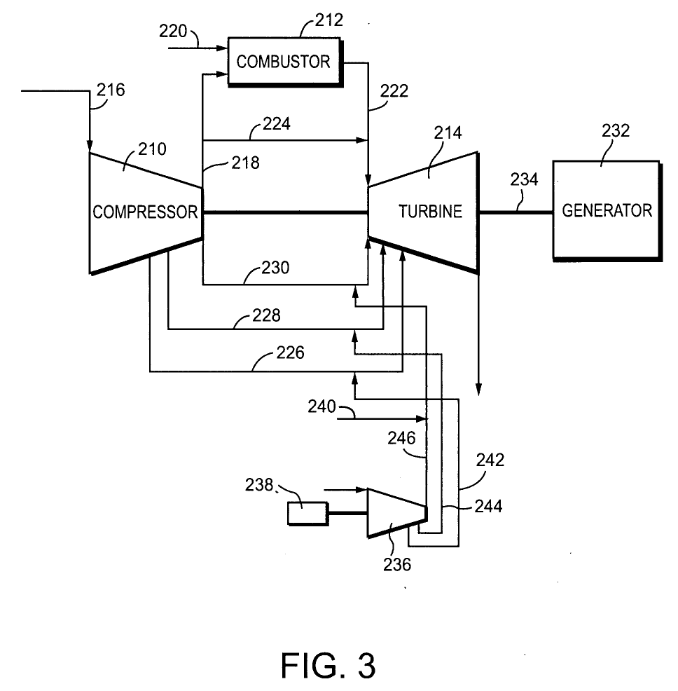

FIG. 3 illustrates a prior art variation where cooling air is supplied by both the integral turbine compressor 210 and by an external compressor 236 (this could be an intercooled compressor) in a pure augmentation technique. In other words, the external compressor 236 is utilized to augment the supply of compressed air from the integral compressor 210 to the turbine component for cooling and sealing purposes. Here, the low, intermediate and high pressure cooling air is supplied by integral compressor 210 via respective streams 226, 228 and 230, but supplemented as necessary by cooling air supplied by external compressor 236 via respective low, intermediate and high pressure streams 242, 244 and 246. Because the cooling duty requirements are augmented by the external compressor 236, the supply of compressed air to the combustor 212 from the compressor 210 is increased, resulting in increased output.

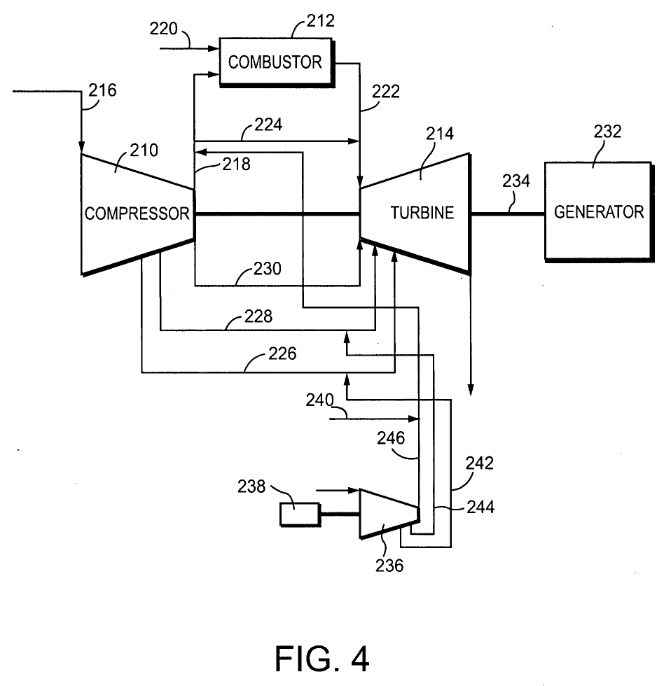

As shown in FIG. 4, in another prior art variation, compressed air from stream 246 can be supplied to the combustor via line 218 (rather than to the turbine section via stream 230) to augment the supply of air from the integral compressor 210. Otherwise, the arrangement in FIG. 4 is identical to the arrangement in FIG. 3. Moreover, the augmented supply of cooling media to the turbine section 214 via streams 242 and 244 can be shut off, so that the external compressor augments the air supply only to the combustor.

It is known that humidification of the cooling media can be added to the separate air cooling media supply system. One suitable means of humidification employs a saturator and hot water heated by waste or primary energy. Moisture introduction is shown in FIGS. 2, 3, and 4 via streams 140, and 240, respectively. It is also known that waste heat is readily available from the turbine exhaust in single cycle systems for evaporation of water that can then be introduced into any of the discharge air streams of compressor 136 or 236, as appropriate. The coolant supply system can modulate the flow, pressure, temperature and composition of the supplied cooling media.

The above described systems thus provide increased power capability for a gas turbine, particularly when ambient temperature rises to a level that causes reduced flow to the integral turbine compressor, resulting in reduced output. In other words, as ambient temperature rises and air flow into the turbine compressor decreases, the external compressor 136 or 236 may be employed to maintain or increase output by supplying all, or additional, cooling air (or other cooling media) in an amount necessary to optimize the flow of cooling air to the hot gas path parts of the turbine sections and/or to augment the flow of air or other cooling media to the combustion process. Further in this regard, by using an external compressor, greater cooling air flow can be provided than that available from the integral turbine compressor since only a small percentage of air from the turbine compressor is available for cooling duty. In other words, in conventional systems the amount of cooling air is limited by the capacity of the integral compressor. By supplying cooling air from an external compressor, where all of the air or other cooling media may be used for cooling duty, the turbine compressor can supply more air to the combustion process, thereby increasing turbine output. This is true whether the external compressor 136, 236 is used alone or in conjunction with the integral turbine compressor 110, 210.

That is not to say, however, that further improvement to the above described systems cannot be made. Indeed, the invention disclosed herein relates to further system improvements relating to supplying augmenting compressed air and/or cooling media via a separate compressor.

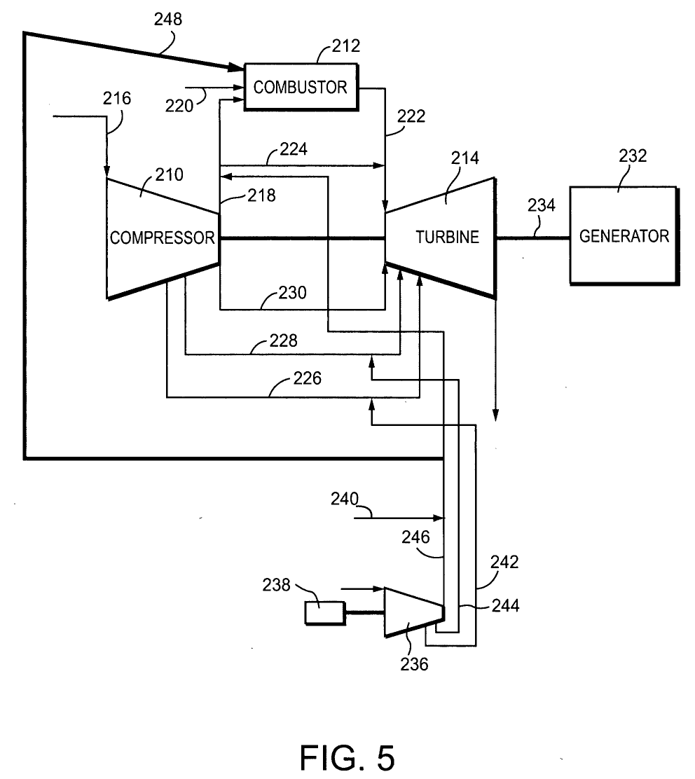

Typically a gas turbine is configured as a dual fuel unit. In this regard, provision is made for the combustor to burn either natural gas or oil fuel. For adequate operation on oil fuel, conventionally the unit is equipped with an atomizing air (AA) skid. This conventional skid comprises high pressure compressors that provide air to the liquid fuel tip to atomize the fuel spray. In most cases, the oil fuel (and AA skid) are rarely used, e.g., during required maintenance or during temporary disruption in gas fuel supply, or as determined by fuel costs tradeoffs. In accordance with an embodiment of the invention, as illustrated in FIG. 5, the external compressor provides not only cooling air, independently or to augment the integral combustor and possibly power augmentation air (as described above, with reference to FIGS. 2-4), but the compressed air 248 from the external compressor 236 can be selectively used as the atomizing air, thereby eliminating the atomizing air skid. In view of the limited use of oil fuel and thus atomizing air therefor, significant capital costs savings will be seen by selectively conducting compressed cooling air 248 from the external compressor 236 for use as atomizing air.

According to a further feature of the invention, an external compressor may be used as a means to increase the gas turbine turndown. Turndown is defined as the lowest load at which the gas turbine can operate in emissions compliance. For Dry Low NOx (DLN) combustors, this is dependent on the combustor exit temperature. Below a certain temperature premixed combustion is no longer possible and the combustor is transferred to other modes (diffusion combustion for example). These not fully premixed modes result in much higher emissions and prevent the unit from operating because of enforced emissions regulations. Consequently it would be desirable to maintain the combustor exit temperature above a certain limit, at lowest load possible (desirable up to Full Speed No Load or even spinning reserve). If this would be possible the operator of a gas turbine would have the greatest operability flexibility. In the prior art extended turndown is accomplished for example by reducing the inlet guide vanes. In this way the airflow to the combustor is reduced and higher temperatures can be maintained at low loads. The limit to which the airflow can be reduced (below which the compressor cannot operate—there are also mechanical limits) limits the turndown. Now consider a gas turbine according to the present invention in which the cooling air can be supplied by either the external compressor or the integral compressor. At the minimum (integral) compressor airflow, the external compressor is turned off and required cooling flow is now supplied by the integral compressor (by energizing a control valve). This results in further decreasing the combustor air flow, at constant compressor flow. As a consequence, elevated combustor exit temperature can be maintained at lower loads, and the turndown is increased.

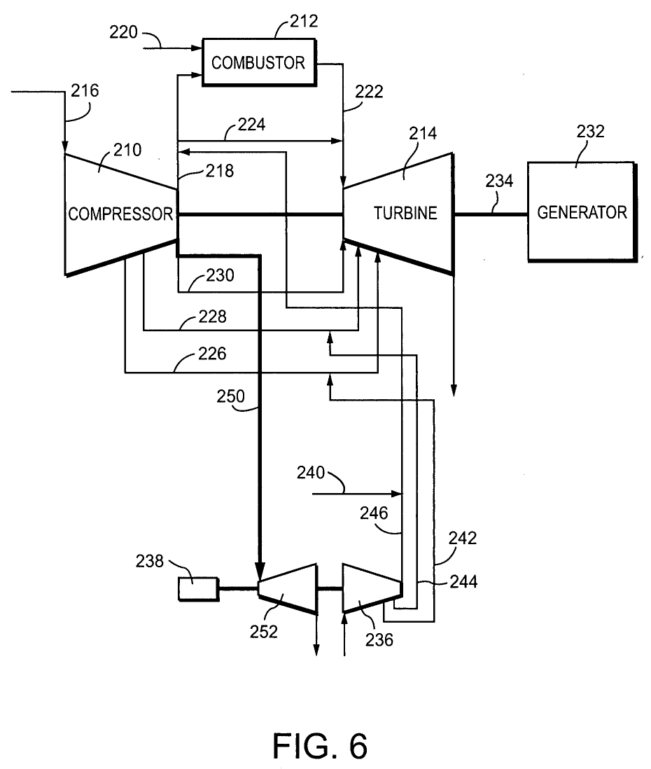

Another, prior art method to increase turndown is to use OBB (over board bleed). In this case, at the minimum compressor airflow, turndown is increased by discharging some of the compressed air into atmosphere, in order to reduce the airflow to the combustor and allow high combustor exit temperatures. Obviously this is done at a considerable loss for the customer because compressed air is lost for the cycle. Assuming that using the extra air for cooling could lead to increased complexity, according to another embodiment of the present invention, illustrated in FIG. 6, the compressed OBB air 250 (otherwise lost to the ambient) is expanded in a turbine 252 (similar to the automobile superchargers) to produce some (or all) of the work required to compress the cooling air in the external compressor 236. An electric motor 238 could be used in parallel to cover any power deficit.

As yet a further alternative to the above, the external compressor is used at low loads only to increase turndown. Thus, during normal operation a prior art configuration as in FIGS. 2-4 is used. Then, at low loads OBB is used to drive a small external compressor to provide the cooling air as in FIG. 6.

According to a further feature of the invention, the external air (for all purposes: cooling, atomizing air, power augmentation etc) is delivered through a reservoir. This would allow tremendous flexibility and optimization possibilities. For example any type of compressor (including reciprocating compressors or mixed combinations) could be used while maintaining the required parameters (flow, pressure, temperature, steadiness) at the engine ports. In addition economicity of the power plant could be substantially improved. There are many instances where the engines are operated cyclically. Output is valued during peak demand (usually day time) but customers may have excess capacity during night. During reduced demand the electricity price is low or the customers could be forced off grid. In order to better take advantage of the peak hours and swings in demand, most customers choose to keep the units running at a loss during night at some parking mode (at lowest load possible—biggest turndown). Using an external compressor with a storage tank would allow the customer to use the extra capacity to generate the air required during the day and minimize the power consumption in the external compressor during peak hours.

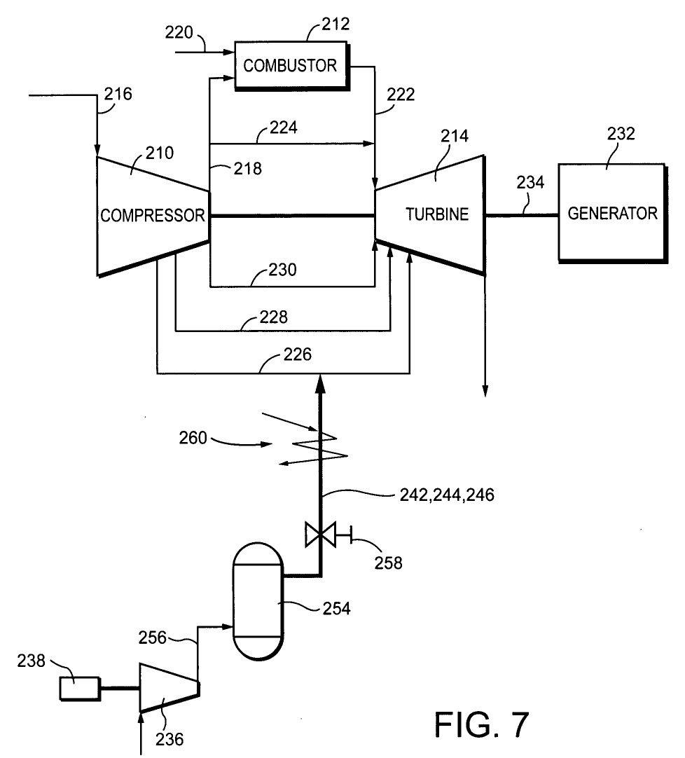

Thus, according to a further feature of the invention, a compressed air storage and retrieval system is provided and, in the embodiment illustrated in FIG. 7, includes an external compressor 236 driven by an electric motor 238 to supply compressed air to compressed air storage 254 via charging structure 256 in the form of piping.

As schematically illustrated, an outlet of the compressed air storage 254 is fluidly coupled to the cooling air supply lines 226, 228, 230 extending from the integral compressor 210 to the turbine 214. In the illustrated embodiment, a valve 258 is provided between an outlet of the compressed air storage and the supply lines.

The compressed air storage may be an underground geological formation such as a salt dome, a salt deposition, an aquifier, or may be made from hard rock. Alternatively, the air storage 254 may be a man-made pressure vessel which can be provided above-ground.

As illustrated in FIG. 7, a heat exchanger 260 may be provided between the external compressor 236 (or tank 254 as the case might be) and the turbine to control the temperature of the cooling media. The cooling effectiveness depends on flow and temperature. For the same flow, cooling effectiveness could be increased for lower temperature. This allows for optimization and tradeoffs between power consumption, size of the compressor, and variable (actual cycle conditions) cooling requirements. The heat exchanger could be closed or open loop.

Although only one combustion turbine assembly is shown in the embodiments described herein it can be appreciated that numerous combustion turbine assemblies may be provided and coupled with a common external compressor and/or with a common compressed air storage to provide the desired cooling air flow, augmented air flow and/or power augmentation.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A land based combustion gas turbine apparatus comprising:
an integral compressor;
a turbine component;
a combustor to which air from the integral compressor and fuel are supplied, said combustor arranged to supply hot combustion gases to the turbine component;
a generator operatively connected to the turbine for generating electricity; and
an external compressor arranged and connected to supply cooling air or other cooling media to hot gas path component parts in said turbine component, said external compressor also being arranged and connected to selectively supply atomizing air to atomize said fuel supplied to said combustor.

2. The apparatus of claim 1 wherein at least low and intermediate pressure cooling air or other cooling media is supplied by said external compressor.

3. The apparatus of claim 1 wherein all cooling air or other cooling media supplied to said turbine component is supplied by said external compressor.

4. A land based combustion gas turbine apparatus comprising:
an integral compressor;
a turbine component;
a combustor to which air from the integral compressor and fuel are supplied, said combustor arranged to supply hot combustion gases to the turbine component;
a generator operatively connected to the turbine for generating electricity;
an external compressor arranged and connected to supply compressed air to a storage chamber for selectively storing said compressed air, an outlet of said storage chamber being connected to supply said compressed air as cooling media from the storage tank to hot gas path component parts in said turbine component.

5. A land based combustion gas turbine apparatus as in claim 4, wherein said outlet of said storage chamber is operatively coupled to cooling air supply lines extending from said integral compressor to said turbine.

6. A land based combustion gas turbine apparatus as in claim 4, further comprising a heat exchanger between said storage chamber and said turbine to control the temperature of the cooling media.

7. A land based combustion gas turbine apparatus as in claim 4, further comprising a valve between an outlet of the compressed air storage chamber and said turbine for selectively controlling flow of cooling media from the compressed air storage chamber thereto.

8. A land based combustion gas turbine apparatus comprising:
an integral compressor;
a turbine component;
a combustor to which air from the integral compressor and fuel are supplied, said combustor arranged to supply hot combustion gases to the turbine component;
a generator operatively connected to the turbine for generating electricity;
an external compressor arranged and connected to supply cooling air or other cooling media to hot gas path component parts in said turbine component; and
an external turbine for producing at least some of the work required to compress the cooling air in the external compressor, wherein said integral compressor is operatively coupled to said external turbine for selectively supplying compressed air from said integral compressor to said external turbine.

9. A land based combustion gas turbine apparatus as in claim 8, further comprising an electric motor coupled in line with said external turbine for selectively operating said external compressor.

10. A method of insuring peak power capability for a land based gas turbine power plant including an integral compressor, a turbine component, a combustor and a generator, wherein hot gas path parts in the turbine component are cooled by cooling air, the method comprising:
a) supplying compressed air to said combustor from said integral compressor;
b) supplying cooling air or other cooling media to said hot gas path parts in the turbine component from an external compressor; and
c) supplying compressed air from said external compressor to atomize fuel supplied to the combustor.

11. The method of claim 10, wherein step (b) is commenced as a function of ambient temperature.

12. The method of claim 9, wherein step (b) is commenced as a function of air flow rate through the integral compressor.

13. The method of claim 10, wherein at least low and intermediate pressure cooling air or other cooling media is supplied by said external compressor.

14. The method of claim 10, wherein all of the cooling air or other cooling media supplied to said hot gas path parts is supplied by the external compressor.

15. The method of claim 9, wherein step (b) comprises supplying compressed air from said external compressor to a storage chamber and selectively supplying said compressed air from said storage chamber to said hot gas path parts in the turbine component.

16. The method of claim 13, further comprising controlling the temperature of the compressed air supplied from said storage chamber to said turbine component with a heat exchanger disposed between said storage chamber and said turbine component.

17. The method of claim 13, wherein said outlet of said storage chamber is operatively coupled to cooling air supply lines extending from said integral compressor to said turbine.

18. The method of claim 15, further comprising controlling the temperature of the compressed air supplied from said storage chamber to said cooling air supply lines with a heat exchanger disposed between said storage chamber and said cooling air supply lines.
